(19) United States
(12) Patent Application Publication
(10) Pub. No.: US 2003/0179576 A1
(43) Pub. Date: Sep. 25, 2003

(54) Tent lighting fixture

(76) Inventor: Chun-Hsiung Huang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/102,675

(22) Filed: Mar. 22, 2002

(51) Int. Cl. F21V 33/00

(52) U.S. Cl. 362/253; 362/190; 362/191

(57) ABSTRACT

A lighting fixture exclusively for use in a tent comprises an independent lighting fixture attached to a vault of an inner tent by means of a magic tape, a double-faced adhesion tape or a clamp to provide an easy, convenient and efficient lighting in the tent.

### BACKGROUND OF THE INVENTION

(a) Field of the Invention

The present invention relates to a tent lighting fixture, and more particularly to one that can be easily fixed to a vault of an inner tent inside the tent.

(b) Description of the Prior Art

To enjoy a pleasant and comfortable camping out in the filed, one has to prepare the camping equipment with the basic including the tent, cooking set, cutlery set, stove accessories, chair and desk, bed and mattress, lighting. Missing any item could never be a romantic situation. Of course, the tent is the most important. Even though source sockets are available in most of the camping sites to make camping light emitting a charisma that is beyond description by words; lighting is also a must inside the tent. Lantern using DC or AC source, liquid gas or gasoline is available for the purpose. The lantern, being easy to carry for use and providing sufficient light, is convenient and economic. However, lantern burning gas or gasoline is not applicable inside the tent for fire concerns. Generally, lighting fixture used inside the tent is either rechargeable or operates on battery. The problem is that such lighting fixture operating on electricity is not designed exclusively for application in the tent. Therefore, it's not unusual to see that flashlight is tied to the roof inside the tent since there is no tube or rod, or its joint built in the tent to secure the lighting fixture, resulting in that there is no place on the surface of the inner tent to harbor the lighting fixture.

### SUMMARY OF THE INVENTION

The primary purpose of the present invention is to provide a lighting fixture exclusively to be used in the tent by allowing it be conveniently attached to the roof inside the tent. To achieve this purpose, the lighting fixture of the present invention is composed of multiple independent units and secured to the vault in the tent by means of a magic tape, a double-faced adhesion tape or a clamp.

### BRIEF DESCRIPTION OF THE DRAWINGS

FIG. 1 is a perspective view of a preferred embodiment of the present invention;

FIG. 2 is a cross sectional view showing an assembly of the preferred embodiment is in use;

FIG. 3 is a local view of a lighting fixture of the preferred embodiment is fixed by use of a double-faced adhesion tape; and

FIG. 4 is a local view of the lighting fixture of the preferred embodiment is fixed by means of a clamp.

### DETAILED DESCRIPTION OF THE PREFERRED EMBODIMENTS

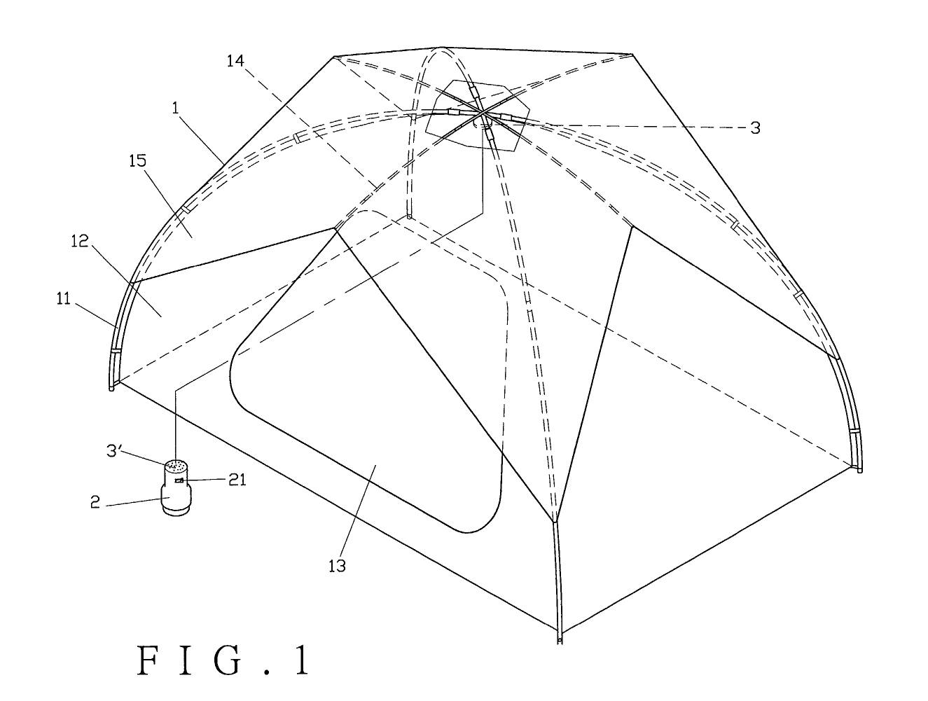

Referring to FIG. 1, a lighting fixture (2) of a preferred embodiment of the present invention is provided in a tent (1) (a yurt in this case for illustration purpose). Wherein, the tent (1) is essentially composed of an inner tent (12) supported by two long elastic strainers (11) crossly erected; an entrance (13) provided on one side of the inner ten (12); an outer tent (15) supported by two shorter elastic strainers (14). A pre-sewn fixation member (3), e.g. a magic tape, is provided on the vault of the inner tent (12) with either the loop side or the hook side facing outward to be adapted to the lighting fixture (2).

The lighting fixture (2) is an independent unit having the power supplied by batteries generally available in the market or by a rechargeable source; an LED filament is preferred and a switch (21) is provided to the LED; and another fixation member (3′), also in the form of a magic tap having its hook or loop opposite to that side of the fixation member (3) sewn in the tent (1).

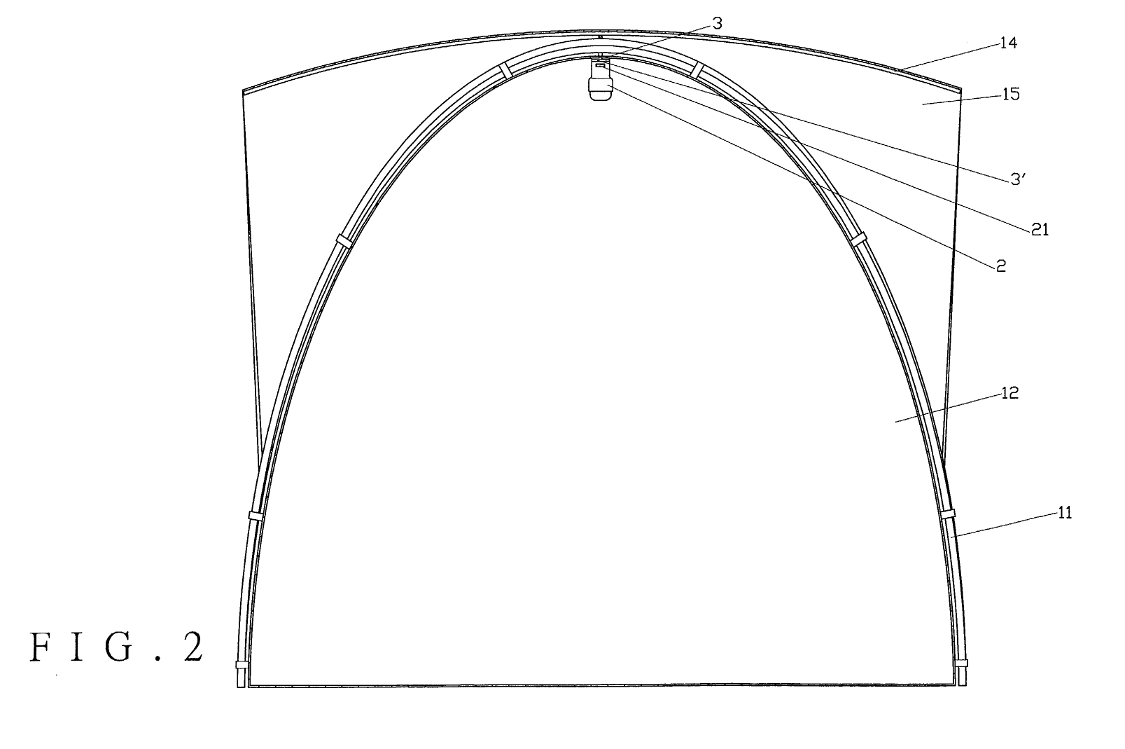

As illustrated in FIG. 2, the lighting fixture (2) is attached to the vault of the inner tent (12) by their corresponding fixation members (3, 3′) for the lighting fixture (2) to be held in position at the vault of the inner tent (12) to having optimal lighting direction while the LED provides excellent lighting effect without the concern that the tent may be burnt as may be found with lighting fixture of the prior art that relies upon inflammable fuel.

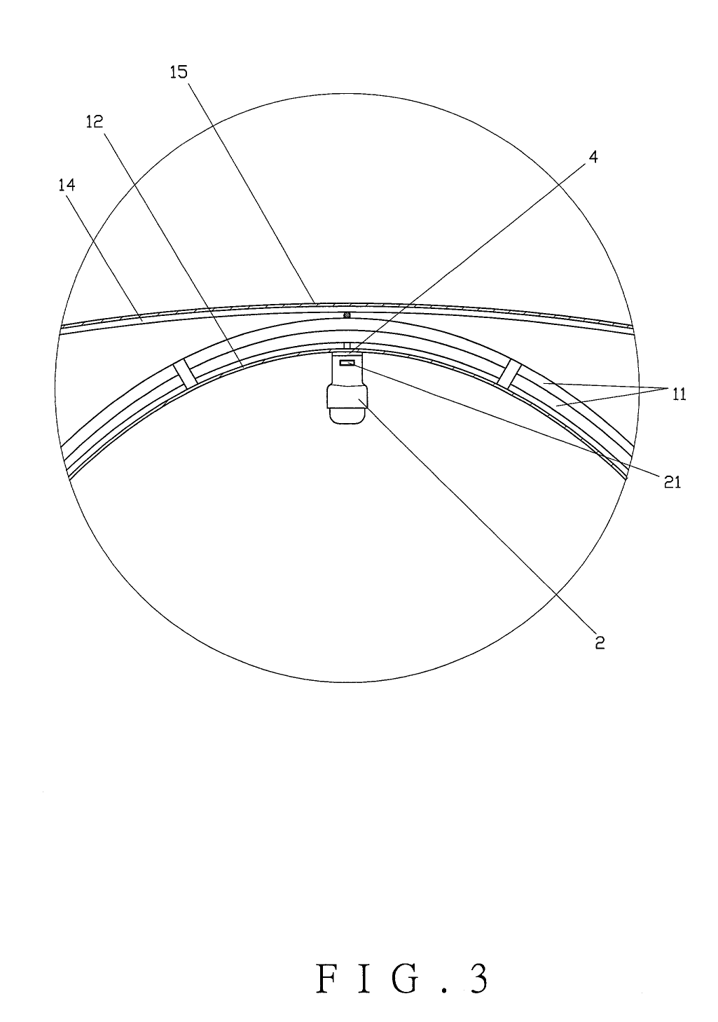

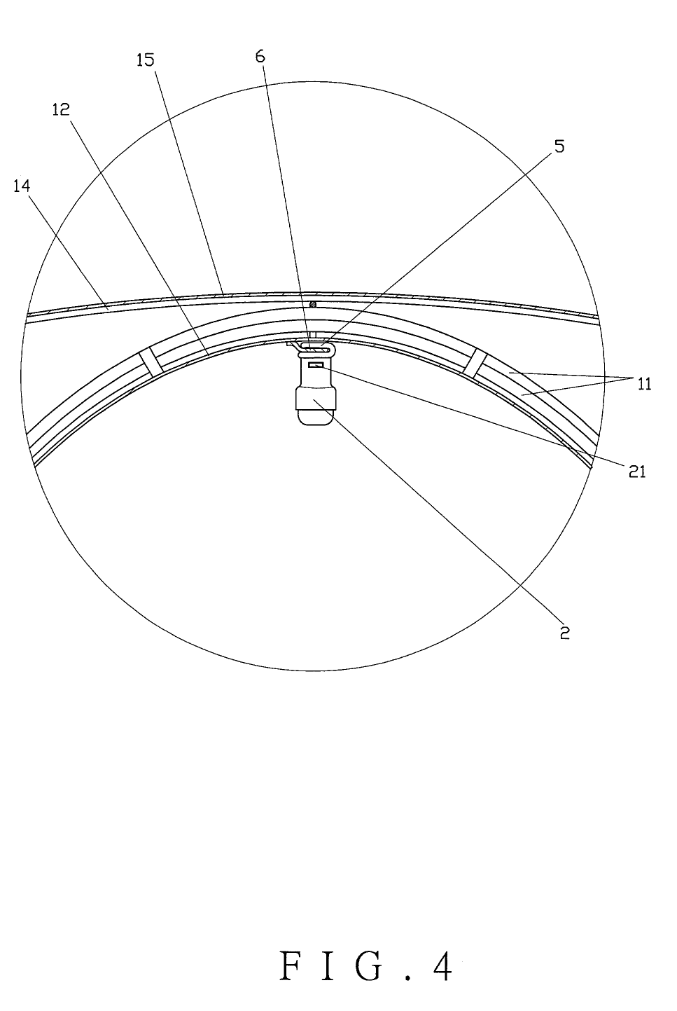

Furthermore, the fixation of the light fixture (2) by means of the fixation members (3, 3′) is not the only alternative. A double-faced adhesion tape (4) with sufficient binding strength as illustrated in FIG. 3, or a clamp (5) provided at the top of the lighting fixture (2) as illustrated in FIG. 4 are practical solutions. Wherein, the clamp (5) can hold to any fabric (6) provided inside the inner tent (12) of the tent (1) to hold the lighting fixture (2). Accordingly, the lighting fixture (2) can be directly and easily attached to any fixed article on the tent (1) as desired.

As disclosed, the present invention for allowing to be easily and conveniently fixed to the inner tent by means of a magic tape, a double-faced adhesion tape or a clamp while permitting easy removal is innovative with improved practical use when compared to its prior art by tying up a flashlight with a rope.

I claim:

1. A tent lighting fixture comprising an individual unit of light provided a fixation member to be attached to a vault of an inner tent inside a tent.

2. A tent lighting fixture as claimed in claim 1, the fixation member is a magic tape, a double-faced adhesion tape or a clamp.
